(19) United States
(12) Patent Application Publication
(10) Pub. No.: US 2024/0033700 A1
(43) Pub. Date: Feb. 1, 2024

(54) Method for Monitoring the Wetting Height of a Mixing Cup

(71) Applicant: MARCO Systemanalyse und Entwicklung GmbH, Dachau (DE)

(72) Inventor: Martin Reuter, Dachau (DE)

(21) Appl. No.: 18/139,093

(22) Filed: Apr. 25, 2023

(30) Foreign Application Priority Data
Apr. 29, 2022 (DE) 102022110524.5

(51) Int. Cl. B01F 35/21; B01F 35/22

(52) U.S. Cl. CPC B01F 35/2112; B01F 35/2202; B01F 35/2115

(57) ABSTRACT

In a centrifugal mixer, a maximum wetting height within a mixing cup is optically detected and is regulated by means of a control of drives.

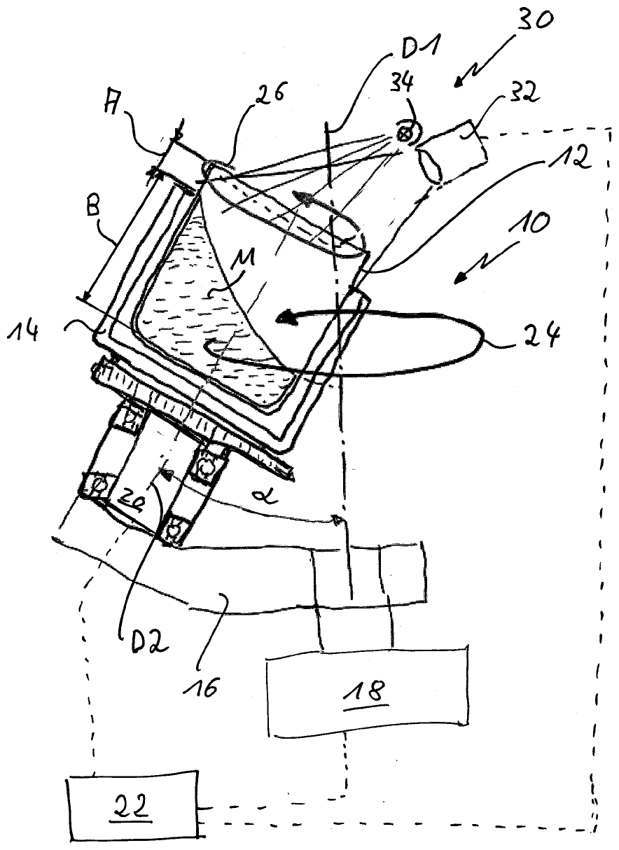

The present invention relates to a method for monitoring the wetting height of a mixing cup in a centrifugal mixer.

In the prior art, centrifugal mixers, also called rotary mixers or planetary mixers, are used for mixing different media; in these mixers, a mixing cup filled with media is set into rotation about two axes of rotation extending obliquely to one another in accordance with the principle of the dual asymmetric centrifuge. Due to the dual rotation of the mixing cup (usually in opposite directions), a particularly efficient production of bubble-free, homogeneous mixtures of media can take place, for example, of adhesives, sealants, powders, etc. This process can also take place under vacuum to simultaneously degas the media or the mixed medium during the mixing. The two rotations in opposite directions, i.e. a rotation of the mixing cup about its own axis and an additional rotation of the mixing cup about a further axis of rotation, which in particular extends obliquely to the first axis of rotation, typically take place with a predefined fixed ratio of the rotational speeds, for example 3:1, in the prior art. In this case, a common drive can be used that effects both rotational movements via a gear.

In such known centrifugal mixers, there is, on the one hand, the problem that medium can escape from the interior of the mixing cup at too high rotational speeds. On the other hand, it is desirable for a good mixing to provide rotational speeds that are as high as possible but that again involve the risk of medium escaping from the mixing cup.

It is therefore the object of the present invention to provide a method for monitoring the wetting height of a mixing cup in a centrifugal mixer by which the mixing of media can be optimized and an escaping of medium from the mixing cup can be reliably prevented.

This object is satisfied by a method having the features of claim 1. In this method, the wetting height of a mixing cup in a centrifugal mixer is monitored. In this respect, the wetting height is understood as that height up to which a medium present in the mixing cup extends to the maximum during operation due to the centrifugal forces present. If, for example, the wetting height is greater than the height of the inner wall of the mixing cup, medium escapes from the interior of the mixing cup during operation.

In the method in accordance with the invention, the mixing cup filled with media is set into rotation about two axes of rotation extending obliquely to one another (in particular in opposite directions), and indeed by means of a first drive and a second drive, wherein the two drives can be controlled or are controlled independently of one another. Furthermore, the wetting height within the mixing cup is optically detected by means of an image acquisition device. The two drives are then controlled by a control such that a predefined wetting height is reached and/or is not exceeded. This can take place by setting the rotational speed of the first and/or the second drive.

Due to the optical detection of the wetting height and the resulting control of the drives of the centrifugal mixer, an escaping of medium from the mixing cup during operation can be reliably prevented. At the same time, the drives can be controlled such that as good as possible a mixing of the media present in the mixing cup takes place by driving them at a maximum permissible rotational speed. The amount of the medium to be mixed in the mixing cup can also be optimized by, for example, reducing the inclination of the mixing cup but maximizing the wetting height during operation.

Advantageous embodiments of the invention are described in the description, in the drawing, and in the dependent claims.

In accordance with a first advantageous embodiment, there is the possibility of entering a maximum wetting height into the control. It can hereby be ensured by means of the control that a predefined wetting height is reached and/or that the maximum wetting height is not exceeded by setting the rotational speed of the first and/or the second drive accordingly.

In accordance with a further advantageous embodiment, the control can regulate the wetting height to a predefined desired value. Therefore, if the density or the volume of the medium within the mixing cup changes, for example due to a degassing, the predefined wetting height can be maintained by regulating the rotational speed of the first and/or the second drive.

In accordance with a further advantageous embodiment, the image acquisition device can have a stationary image sensor, such as a camera, by which an image of the interior of the mixing cup is acquired. For this purpose, the mixing cup can be illuminated by a pulsed light source that is synchronized with at least one of the drives. A still image can hereby be produced that is synchronized with the rotation of the mixing cup and that can, in turn, be evaluated by the image acquisition device to determine the actually present wetting height present within the mixing cup. Furthermore, it can be advantageous if radiation that has at least two different color temperature maxima, in particular at least three different color temperature maxima, is emitted by the light source. Since different media, which cannot always be recognized equally well with only one wavelength, are usually mixed in the mixing cup, an illumination with different colors, for example RGB, enables a more reliable determination of the wetting height.

In accordance with a further advantageous embodiment, the temperature of a medium in the mixing cup can be detected by means of an optical temperature detection device, for example an infrared measurement device, wherein the rotational speed of at least one drive is regulated by the control such that a predefined maximum temperature is not reached or not exceeded. In this case, the rotational speed of the mixing cup is controlled or regulated on the basis of the temperature measurement in order to achieve a temperature specific to the medium or not to exceed a temperature critical for the medium.

In accordance with a further aspect, the present invention relates to an apparatus comprising a centrifugal mixer comprising at least one mixing cup that can be set into rotation about two axes of rotation extending obliquely to one another by a first and a second drive. Furthermore, an image acquisition device is present by which a wetting height within the mixing cup can be detected. A control of the apparatus is configured and adapted such that it sets, in particular regulates, the rotational speed of the first and/or the second drive such that a predefined wetting height is reached and is in particular not exceeded.

The present invention will be explained purely by way of example in the following with reference to an advantageous embodiment. It is understood in this respect that not all the features of the described advantageous embodiment are to be regarded as essential to the invention.

The FIGURE shows a highly simplified representation of a centrifugal mixer 10 that can set a mixing cup 12 into rotation about two axes of rotation D1 and D2 extending obliquely to one another. For this purpose, the mixing cup 12 is inserted into a holder 14 that is fastened to a rotary arm 16 that can, in turn, be rotated about the axis of rotation D1 by a first drive 18. The axis of rotation D1 can be vertically oriented. However, the rotary arm 16 is angled so that the center axis of the mixing cup 12, which can be identical to the axis of rotation D2, extends at an acute angle α to the first axis of rotation D1. In the embodiment, the mixing cup 12 is therefore oriented obliquely to the vertical.

At the rotary arm 16A, a second drive 20 is provided by which the holder 14 and thus also the mixing cup 12 can be set into rotation about the second axis of rotation D2.

The control of the two drives 18 and 20 takes place via a control 22, wherein the control 22 is, for example, connected via slip rings to the drive 20 rotating about the axis D1.

In operation, the rotary arm 16 rotates about the axis of rotation D1, whereby a centrifugal force acts on media M that are present within the mixing cup 12. For the rotation about the axis D1, the rotational speed or the speed of rotation, which is indicated by the arrow 24, can be regulated over a wide range. Depending on this speed of rotation, the surface of the media M within the mixing cup 12 takes the shape of a rotational paraboloid. The shape of the surface of the media within the mixing cup 12 is rotated proportionally to the rotational speed and independently of the viscosity of the media as long as the mixing cup 12 is simultaneously rotated about the axis D2. The speed of rotation about the axis D2 is indicated by the reference numeral 26. This speed of rotation or the rotational speed of the second drive 20 likewise influences the maximum height which the media M occupy within the mixing cup 12. This is denoted by the reference sign B in the FIGURE and is referred to as the wetting height in the present application.

In the embodiment shown, it is defined by the angle of inclination a of the mixing cup 12 how full the mixing cup 12 can be in the state of rest and what maximum speed of rotation about the axis of rotation D1 is possible in order to prevent any medium from escaping from the mixing cup 12. Without a regulation for the rotational speed of the drives 18 and 20, an angle α of the order of magnitude of can be suitable. For larger filling quantities, it can, however, be advantageous to set and to regulate the rotational speeds of the two drives 18 and 20 individually, whereby the angle α can be selected smaller, which in turn enables larger filling quantities.

As the FIGURE illustrates, there should be a minimum spacing A between the upper edge of the mixing cup 12 and the medium M present in the mixing cup 12 to prevent medium from escaping from the mixing cup. Here, it is clear that the wetting height B can be maximized by reducing the minimum spacing A. To ensure during ongoing operation that, on the one hand, a desired wetting height B is reached and, on the other hand, a minimum spacing A is maintained, an image acquisition device 30 by which the wetting height B within the mixing cup 12 can be detected is provided in the embodiment shown. For this purpose, the image acquisition device has a stationary image sensor 32, for example a digital camera, that acquires an image of the interior of the mixing cup 12 and that determines the actual maximum height of the medium M within the mixing cup 12, i.e. the wetting height B, by means of image evaluation software. To enable a good image evaluation despite the mixing cup 12 rotating about two axes, a pulsed light source 34 is further provided that illuminates at least a portion of the interior of the mixing cup 12, wherein the light source 34 is synchronized with at least one of the drives 18, 20 to produce a still image that can be evaluated. For this purpose, the light source 34 is operated in a pulsed manner in the manner of a stroboscope, wherein the synchronous pulse for controlling the light source 34 and the camera 32 can, for example, be generated by a switching contact or a rotary encoder of the drives 18 and/or 20.

In the embodiment shown, it can be advantageous if the light source 32 emits radiation that has a plurality of different colors, for example at least two, in particular at least three different color temperature maxima, to be able to easily recognize different media within the mixing cup 12.

Furthermore, an optical temperature detection device can be provided that detects the temperature of the medium M in the mixing cup 12, wherein the optical temperature detection device can be coupled to the control 22 so that the latter regulates the rotational speed of at least one drive 18, 20 such that a predefined maximum temperature of the medium M is not reached or not exceeded.

In a method in accordance with the invention for monitoring the wetting height B of a mixing cup 12 in a centrifugal mixer, the mixing cup 12 filled with different media M is set into rotation about the first axis of rotation D1 by means of the first drive 18 and about the second axis of rotation D2 by means of the second drive 20, wherein the two axes of rotation are inclined to one another by the angle α and the rotations are in particular oriented in opposite directions. The wetting height B within the mixing cup 12 can then be detected by means of the image acquisition device 30 during operation. It hereby becomes possible to control the drives 18 and/or 20 by means of the control 22 such that a predefined wetting height B is reached by setting a suitable rotational speed of the first and/or the second drive 18, 20. The control 22 can also control the drives 18, 20 in such a manner that the wetting height B is not exceeded such that a minimum spacing A is always present so that no medium M escapes from the mixing cup 12.

1-8. (canceled)

9. A method for monitoring the wetting height of a mixing cup in a centrifugal mixer, in which method the mixing cup filled with media is set into rotation about two axes of rotation extending obliquely to one another by a first drive and by a second drive, said method comprising the following steps:
optically detecting the wetting height within the mixing cup by means of an image acquisition device,
controlling the drives by a control such that a predefined wetting height is reached or is not exceeded by setting the rotational speed of the first and/or the second drive.

10. The method in accordance with claim 9,
wherein a maximum wetting height is entered into the control.

11. The method in accordance with claim 9,
wherein the control regulates the wetting height to a predefined desired value.

12. The method in accordance with claim 9,
wherein the image acquisition device acquires an image of the mixing cup using a stationary image sensor, wherein the mixing cup is illuminated by a pulsed light source that is synchronized with at least one of the drives, and wherein radiation that has at least two different color temperature maxima is emitted by the light source.

13. The method in accordance with claim 9,
wherein the temperature of a medium in the mixing cup is detected by means of an optical temperature detection device, and wherein the rotational speed of at least one drive is regulated by the control such that a predefined maximum temperature is not reached or not exceeded.

14. An apparatus, comprising:
a centrifugal mixer comprising at least one mixing cup that can be set into rotation about two axes of rotation extending obliquely to one another by a first and a second drive, an image acquisition device by which a wetting height within the mixing cup can be detected, and
a control by which the rotational speed of the first and/or the second drive is set such that a predefined wetting height is reached.

15. The apparatus in accordance with claim 14,
wherein the image acquisition device has a stationary image sensor that acquires an image of the mixing cup, wherein a pulsed light source is provided that illuminates the mixing cup and that is synchronized with at least one of the drives, and wherein the light source emits radiation that has at least two different color temperature maxima.

16. The apparatus in accordance with claim 14,
wherein an optical temperature detection device is provided that detects the temperature of a medium in the mixing cup, and wherein the control is configured to regulate the rotational speed of at least one drive such that a predefined maximum temperature is not reached or not exceeded.

17. The method in accordance with claim 12,
wherein radiation that has at least three different color temperature maxima is emitted by the light source.

18. The apparatus in accordance with claim 14, wherein the apparatus is configured for carrying out a method for monitoring the wetting height of the mixing cup in the centrifugal mixer, in which method the mixing cup filled with media is set into rotation about said two axes of rotation by the first drive and by the second drive, said method comprising the following steps:
optically detecting the wetting height within the mixing cup by means of the image acquisition device,
controlling the drives by the control such that a predefined wetting height is reached or is not exceeded by setting the rotational speed of the first and/or the second drive.

19. The apparatus in accordance with claim 14,
wherein the control by which the rotational speed of the first and/or the second drive is regulated such that a predefined wetting height is reached.

20. The apparatus in accordance with claim 14,
wherein the control is set and/or regulated such that a predefined wetting height is reached and is not exceeded.

21. The apparatus in accordance with claim 14,
wherein the light source emits radiation that has at least three different color temperature maxima.
